(19) United States
(12) Patent Application Publication
(10) Pub. No.: US 2025/0233738 A1
(43) Pub. Date: Jul. 17, 2025

(54) SYSTEMS AND METHODS OF PERSONALIZING CONTACTLESS CARD

(71) Applicant: Capital One Services, LLC, McLean, VA (US)

(72) Inventors: Kevin OSBORN, Newton Highlands, MA (US); Jeffrey RULE, Chevy Chase, MD (US)

(21) Appl. No.: 18/410,191

(22) Filed: Jan. 11, 2024

(51) Int. Cl. H04L 9/08; G06K 19/073

(52) U.S. Cl. CPC H04L 9/0861; G06K 19/07309

(57) ABSTRACT

Methods and systems for personalizing contactless cards are provided. An exemplary method includes: preinstalling, by a server, an applet on the contactless card; assigning, by the server, a first unique identifier to the contactless card; pre-provisioning, by the server, a first unique derived key to the contactless card; generating, by the server a first nonce; generating, by the server, a data file containing script for updating the contactless card and further containing a message authentication code (MAC); transmitting, by the server, the data file and the first nonce to the contactless card; validating, by the contactless card, the MAC based on the first unique derived key and the first nonce; and personalizing the contactless card by the preinstalled applet executing the script.

### FIELD OF THE INVENTION

The present disclosure relates generally to contactless card, and more particularly, to systems and methods for personalizing contactless cards.

### BACKGROUND

Data security and transaction integrity are of critical importance to businesses and consumers. Normally, cards such as credit cards are locked after personalization with little opportunity to change. When a customer is assigned a contactless card, for example, picking up a card at a retail store, the secret keys are needed to convey to the card, which may require secure communication channels and special machines. There are existing standards for personalization, but they require card keys that are not unlockable due to network restrictions.

These and other deficiencies exist. Accordingly, there is a need to provide systems and methods that overcome these deficiencies to personalize contactless cards.

### SUMMARY

Aspects of the disclosed technology include systems and methods of personalizing contactless cards.

Embodiments of the present disclosure provide a method for personalizing contactless cards. The method comprises: preinstalling, by a server, an applet on the contactless card; assigning, by the server, a first unique identifier to the contactless card; pre-provisioning, by the server, a first unique derived key to the contactless card; generating, by the server a first nonce; generating, by the server, a data file containing script for updating the contactless card and further containing a message authentication code (MAC); transmitting, by the server, the data file and the first nonce to the contactless card; validating, by the contactless card, the MAC based on the first unique derived key and the first nonce; and personalizing the contactless card by the preinstalled applet executing the script.

Embodiments of the present disclosure provide a system for personalizing contactless cards. The system comprises a server. The server can be configured to: preinstall an applet on the contactless card; assign a first unique identifier to the contactless card; pre-provision a first unique derived key to the contactless card; generate a first nonce; generate a data file containing script for updating the contactless card and further containing a message authentication code (MAC); transmit the data file and the first nonce to the contactless card; cause the contactless card to validate the MAC based on the first unique derived key and the first nonce; and cause the preinstalled applet to execute the script for personalizing the contactless card.

Embodiments of the present disclosure provide a non-transitory, computer-readable medium comprising instructions for personalizing contactless cards that, when executed on a computer arrangement, cause the computer arrangement to perform actions comprising: preinstalling an applet on the contactless card; assigning a first unique identifier to the contactless card; pre-provisioning a first unique derived key to the contactless card; generating a first nonce; generating a data file containing script for updating the contactless card and further containing a message authentication code (MAC); transmitting the data file and the first nonce to the contactless card; causing the contactless card to validate the MAC based on the first unique derived key and the first nonce; and causing the preinstalled applet to execute the script for personalizing the contactless card.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for personalizing a contactless card according to an example embodiment.

FIG. 2 is a sequence diagram of interactions between components of the system in FIG. 1 according to an example embodiment.

FIG. 3A is a contactless card used for personalization according to an example embodiment.

FIG. 3B is a diagram of the processor of the contactless card in FIG. 3A according to an example embodiment.

FIG. 4 is a flow chart of a method for personalizing a contactless card according to an example embodiment.

FIG. 5 is a flow chart of a method for personalizing a contactless card according to an example embodiment.

FIG. 6 is a flow chart of a method for personalizing a contactless card according to an example embodiment.

FIG. 7 is a flow chart of a method for personalizing a contactless card according to an example embodiment.

### DETAILED DESCRIPTION OF EXAMPLE EMBODIMENTS

The following description of embodiments provides non-limiting representative examples referencing numerals to particularly describe features, teachings, and advantages of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the embodiments may be combined in any suitable manner. A person of ordinary skill in the art will recognize that the embodiments may be practiced without one or more of the specific features, teachings, or advantages of an embodiment. In other instances, additional features, teachings, and advantages may be recognized in certain embodiments that may not be present in all embodiments. A person of ordinary skill in the art will understand that the described features, teachings, and advantages of any embodiment can be interchangeably combined with the features, teachings, and advantages of any other embodiment.

Example embodiments of the present disclosure provide systems and methods for personalizing contactless cards. A contactless card assigned to a user would be preinstalled with an applet that can handle the data storage and signature checking involved in the following steps. That same applet can also be used to execute the day-to-day application of the contactless card or a different applet can be used to execute the day-to-day application of the contactless card in the same security domain. The applet preinstalled on the contactless card can be configured to pre-provision a unique derived key for this card along with an unique identifier used to derive the unique derived key from a master key. This unique identifier can be re-used for the day-to-day application of the card or can be used just for this personalization of the card. After a registration/login authentication of the user, the user would be asked to tap the card to a mobile phone (on which a card application is installed) to retrieve the unique identifier (and potentially other issuer domain information) by the server. An nonce (i.e., Number Used Once) can then be prepared by the server, and a data file containing the script for updating the card (interpreted byte codes.) and also containing a message authentication code (MAC) that uses the unique derived key for the card can also be prepared by the server. The user is asked to tap the card to the mobile phone again, and the script data (and the MAC) is sent by the server to the card through the mobile phone along with the nonce. The card can validate the MAC with the pre-provisioned unique derived key by assembling the data and nonce. The card can then interpret the byte codes (e.g. 0x06 might mean store key 0x02 (location 2) etc.) by the pre-installed applet to update the card.

The present disclosure can be applied to a blank contactless card that can be picked up by a user at a retail store and to an existing card a user is carrying. Example embodiments of the present disclosure would enable a user to keep a card longer and have a nicer card by updating the card. The present disclosure can allow for secure personalization of a contactless card and also allow for other data changes on cards outside of the secure card manufacturing/personalization environment. Normally credit cards are locked after personalization with little opportunity to change. The system and method disclosed herein would create cards with an applet that can perform the authentication function and is pre-provisioned as well. The applet can interpret script such as byte codes that can be used to write further keys and personalization data to the cards or to mutate existing data on the cards.

This unique identifier pre-provisioned on the contactless card can be replaced with another unique identifier contained in the MAC message, which can allow new keys to be derived from the another unique identifier to improve data security.

In some embodiments, a nonce can be used to diversify the keys. When the card is initially read, the session can write a nonce to the card and then the nonce can be used in place of the application transaction counter to further diversify the keys.

In some embodiments, a second nonce in the session can be used. For example, a first nonce can be used for the MAC and a second nonce can be used for the key diversification. Whatever the second nonce is used for the key diversification, both the back end sever and the card have to know it in order to re-diversify the key to make a session to do the future activities like the decrypting.

The card disclosed herein is configured to process scripts. Additional features can be added to the card through scripts. The scripts can be used to either install or activate new features without completely unlocking the card. Usually once a card is locked at personalization time, a new code is not allowed to add to the card. In the present disclosure, however, there are provisions within the applets themselves to change their application state data. It can be code or it can be flags that turns features on.

In the present disclosure, the applet can have a pre-personalized state and an active state. Once the card is personalized, the applet can go into the active state. In an active state, the applet can be further modified without changing the whole applet state but just changing the behavior in the applet by future script updates.

In the present disclosure, there is an initial authentication that validates the “blank” card before preparing the personalization script, and there is a second authentication by the card itself to validate the personalization script's authenticity before storing it on the card.

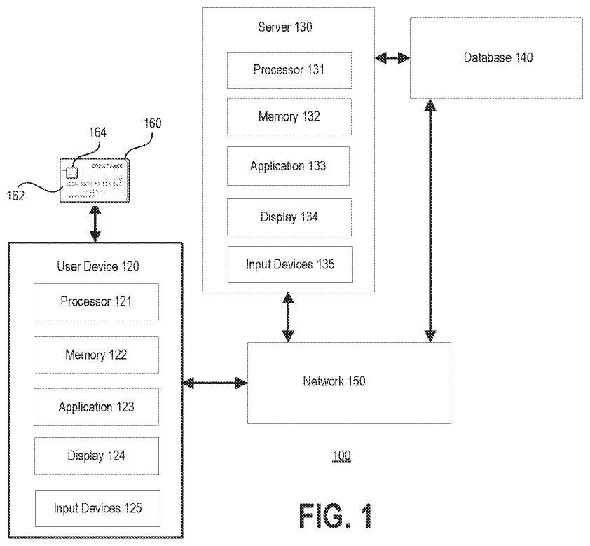

FIG. 1 illustrates a system 100 for personalizing a contactless card according to an example embodiment. As further discussed below, the system 100 may include a user device 120, a server 130, a database 140 in communication using a network 150, and a contactless card 160 in signal communication with the user device 120. Although FIG. 1 illustrates single instances of the components, the system 100 may include any number of components.

The user device 120 can be used by a user to initiate and/or perform transactions with the server 130 using the contactless card 160. The user device 120 may be configured to present to the user a user interface from which the user may log into, for example, their bank or credit card account to access their transaction statement and/or financial information stored in the database 140 of the server 130. The user interface may also be configured to perform data communication with the contactless card 160.

The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, an application 123, a display 124, and input devices 125. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the user device 120. In some examples, the user device 120 may execute one or more applications, such as software applications, that enable, for example, network communications with one or more components of the system 100, transmit and/or receive data, and perform the functions and process flows described herein, such as presenting an account login interface to the user of the user device 120 and reading the contactless card 160. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, microphone, digital camera, video recorder or camcorder. These devices may be used to enter information and interact with the software and other devices described herein such as selecting an option of creating an online account with the merchant.

The server 130 may be associated with an institution, such as a financial institution, and can be configured to communicate with the user device 120. The institution associated with the server 130 may issue the contactless card 160 to the user and accordingly may authenticate the user based on the contactless card 160.

The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the server 130. In some examples, the server 130 may execute one or more applications, such as software applications, that enable, for example, network communications with one or more components of the system 100, transmit and/or receive data, and perform the functions and process flows described herein. Upon execution by the processor 131, the application 133 may provide the functions described in this specification, specifically to execute and perform the steps and functions in the process flows described herein. For example, a card authentication module of the application 133 may be executed to perform authenticating the user based on the contactless card 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, microphone, digital camera, video recorder or camcorder. These devices may be used to enter information and interact with the software and other devices described herein.

The database 140 may be one or more databases configured to store date, including without limitation, private information of users, financial accounts of users, contactless card information, online merchant account information, transactions of users, and merchant records indicative of corresponding merchants. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the user device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the server 130, and user device 120 using the network 150 can occur using one or more front channels and one or more secure back channels. A front channel may be a communication protocol that employs a publicly accessible and/or unsecured communication channel such that a communication sent to the server 130, and/or user device 120 may originate from any other device, whether known or unknown to the server 130, and/or user device 120, if that device possesses the address (e.g., network address, Internet Protocol (IP) address) of the server 130, and/or user device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the server 130, and/or user device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card 160 may be any type of card, such as a security card, a payment card, an identification card, and the like. The contactless card 160 may be issued to the user by the financial institution for identity verification for the bank account of the user.

The contactless card 160 can be configured to transmit a cryptogram to the user device 120 upon tapping to the user device 120. The user device 120 may be configured to read the cryptogram from the contactless card 160 after entry of the contactless card 160 into a communication field of the user device 120. The user device 120 may then transmit the cryptogram to the server 130. The server 130 may be configured to verify the cryptogram by searching the database 140. The server 130 may be configured to transmit scripts to the contactless card 160 to personalize or update the contactless card 160.

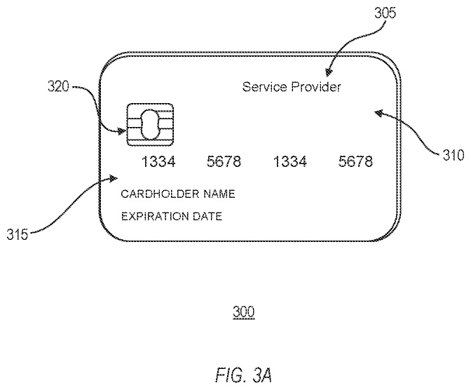

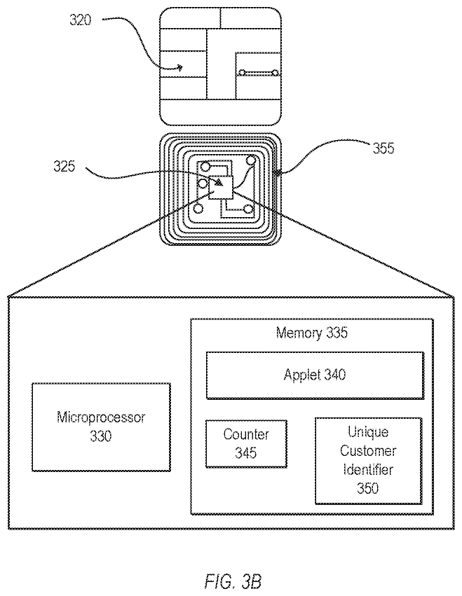

The contactless card 160 can perform authentication and numerous other functions that may otherwise require a user to carry a separate physical token in addition to the contactless card 160. By employing a contactless interface, the contactless card 160 may be provided with a method to interact and communicate between a user's device (such as a mobile phone or the user device 120) and the card itself. For example, the Europay, Mastercard, and Visa (EMV) protocol, which underlies many credit card transactions, includes an authentication process which suffices for operating systems for Android® but presents challenges for iOS®, which is more restrictive regarding near field communication (NFC) usage, as it can be used only in a read-only manner. Exemplary embodiments of the contactless card 160 described herein utilize NFC technology. The contactless card 160 may comprise a substrate 162 and a contact pad 164. Details of an example contactless card will be described in FIGS. 3A and 3B.

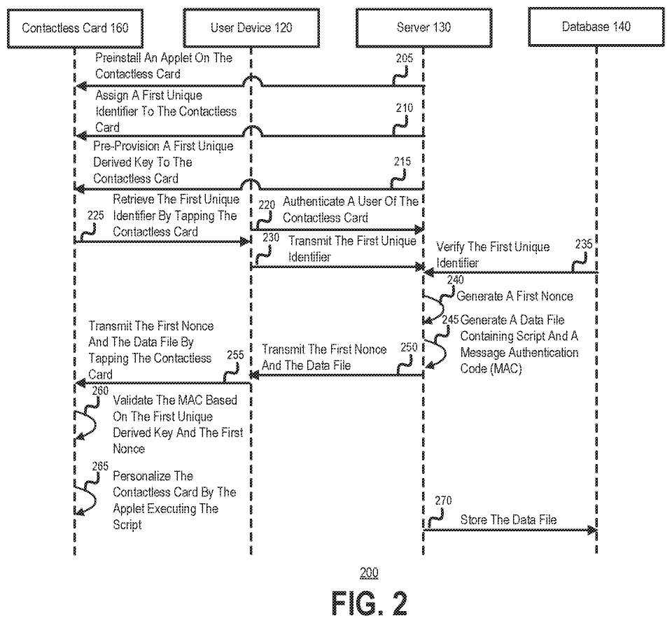

FIG. 2 illustrates an example sequence diagram 200 of interactions between the components of the system 100 according to an example embodiment. FIG. 2 may reference the same or similar components as those illustrated in FIG. 1, including a user device, a server, a database, and a contactless card.

When a user is issued with a contactless card 160, the contactless card 160 may be a blank card. At step 205, the server 130 may preinstall an applet on the contactless card 160. The preinstalled applet can be a Java-based mobile application or other programming language-based application.

At step 210, the server 130 may generate and assign a first unique identifier to the contactless card 160. The first unique identifier can be used to uniquely identify the contactless card 160, and also can be diversified to generate derived keys for the contactless card 160.

At step 215, the server 130 may pre-provision a first unique derived key to the contactless card 160. The first unique derived key can be derived by the server 130 by diversifying the first unique identifier. The first unique derived key may be a session key that can be used to generate and/or authenticate a message authentication code (MAC).

At step 220, the server 130 may authenticate the user of the contactless card 160. For example, the user may be asked to log into his/her financial account associated with the financial institution of the server 130. The user may use the user device 120 to input his/her login credentials.

At step 225, after the user is authenticated, the user is asked to tap the contactless card 160 to the user device 120 to retrieve the first unique identifier pre-stored on the contactless card 160. The user device 120 may include an NFC interface configured for establishing an NFC communication with other NFC-equipped devices (e.g., the contactless card 160 in this embodiment). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the contactless card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the user device 120 can receive from the contactless card 160 NFC response information (e.g., including the first unique identifier of the contactless card 160) usable by the server 130 to verify the contactless card 160 and/or the user. The NFC response information may further be or include, for example, security information encrypted by the contactless card 160 using a private key unique to the card that is known only to the card account administrator (e.g., the server 130).

At step 230, the user device 120 transmits the NFC response information including the first unique identifier of the contactless card 160 to the server 130. At step 235, the server 130 may verify the first unique identifier. For example, the server 130 may search the database 140 for the first unique identifier and then verify it.

At step 240, the server 130 may generate a first nonce and at step 245, generate a data file containing script and a message authentication code (MAC). The MAC may be generated by the server 130 using the first unique derived key, the first unique identifier and the first nonce.

At step 250, the server 130 may transmit the first nonce and the data file to the user device 120. At step 255, the user is asked to tap the contactless card 160 to the user device 120. Upon tapping the contactless card 160 to the user device 120, the user device 120 may transmit the first nonce and the data file to the contactless card 160 by tapping the contactless card 160.

At step 260, the preinstalled applet on the contactless card 160 can validate the MAC based on the first unique derived key and the first nonce. For example, the preinstalled applet on the contactless card 160 may regenerate a MAC based on the first unique identifier, the first unique derived key and the first nonce, and then compare the regenerated MAC and the received MAC to determine whether they match each other. If the regenerated MAC and the received MAC match each other, then the data file can be determined to be authenticated and be from the server 130. If the regenerated MAC and the received MAC do not match each other, then the data file can be determined to be fraudulent and then can be discarded.

Once the received MAC is validated, at step 265, the preinstalled applet on the contactless card 160 can executing the script contained in the data file to update or personalize the contactless card 160. For example, by executing the script, the preinstalled applet may derive a second derived key and additional keys based on the first unique identifier. Further, the preinstalled applet may assign a second unique identifier to the contactless card 160, and derive a second derived key and additional keys based on the second unique identifier. The first unique identifier may be retained or discarded. The preinstalled applet may further write to the contactless card 160 additional information, such as information about the financial institution that issues the contactless card 160, and counters that can facilitate validating the contactless card 160.

At step 270, the server 130 may store on the database 140 the data file, the second unique identifier and/or the second derived key and additional keys.

FIG. 3A describes a contactless card 300 that can be used in the system 100 of FIG. 1. The contactless card 160 in FIG. 1 can be the contactless card 300 described herein. The contactless card 300 is configured to communicate with the user device 120 of system 100. The contactless card 300 may comprise a payment card, such as a credit card, debit card, or gift card, issued by a service provider 305 (such as a bank associated with the server 130) displayed on the front or back of the contactless card 300. In some examples, the contactless card 300 is not related to a payment card, and may comprise, without limitation, an identification card, a membership card, and a transportation card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, or tablet computer. The contactless card 300 may also include processing circuitry, antenna and other components. These components may be located behind the contact pad 320 or elsewhere on the substrate. The contactless card 300 may also include a magnetic strip or tape, which may be located on the back of the contactless card 300.

FIG. 3B illustrates an example contact pad 320 of the contactless card 300. The contact pad 320 of the contactless card 300 may include processing circuitry 325 for storing and processing information, including a processor 330 and a memory 335. It is understood that the processing circuitry 325 may contain additional components, including processors, memories, error and parity/CRC checkers, data encoders, anticollision algorithms, controllers, command decoders, security primitives and tamperproofing hardware, as necessary to perform the functions described herein.

The memory 335 may be a read-only memory, write-once read-multiple memory or read/write memory, e.g., RAM, ROM, and EEPROM, and the contactless card 300 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some embodiments, the memory 335 may also have stored public and private card encryption keys. In some embodiments, the private and public encryption keys may be permanently hard-wired into the memory 335. In various embodiments, the memory 335 may have stored therein instructions for generating encrypted information and transmitting it to a receiving device (e.g., the user device 120). Such encrypted information may be or include an encrypted verification block or signature that may be used to authenticate and verify the presence of the card 300 during transaction processing. In some embodiments, encrypted information may be unique to a particular communication (e.g., a particular NFC transmission by the card 300).

The memory 335 may be configured to store one or more applets 340, one or more counters 345, and a unique customer identifier 350. The one or more applets 340 may comprise one or more software applications configured to execute on one or more contactless cards, such as Java Card applet, and perform the functions and process flows described herein. However, it is understood that the one or more applets 340 are not limited to Java Card applets, and instead may be any software application operable on contactless cards or other devices having limited memory. The one or more counters 345 may comprise a numeric counter sufficient to store an integer. The unique customer identifier 350 may comprise a unique alphanumeric identifier assigned to a user of the contactless card 300, and the identifier may distinguish the user of the contactless card 300 from other contactless card users. In some examples, the customer identifier 350 may identify both a customer and an account assigned to that customer and may further identify the contactless card 300 associated with the customer's account.

The processor 330 and memory 335 elements of the foregoing exemplary embodiments are described with reference to the contact pad 320, but the present disclosure is not limited thereto. It is understood that these elements may be implemented outside of the contact pad 320 or entirely separate from it, or as further elements in addition to the processor 330 and the memory 335 elements located within the contact pad 320.

In some examples, the contactless card 300 may comprise one or more antennas 355. The one or more antennas 355 may be placed within the contactless card 300 and around the processing circuitry 325 of the contact pad 320. For example, the one or more antennas 355 may be integral with the processing circuitry 325 and the one or more antennas 355 may be used with an external booster coil. As another example, the one or more antennas 355 may be external to the contact pad 320 and the processing circuitry 325.

In an embodiment, the coil of contactless card 300 may act as the secondary of an air core transformer. A terminal (such as the user device 120) may communicate with the contactless card 300 by cutting power or amplitude modulation. The contactless card 300 may infer the data transmitted from the terminal using the gaps in the contactless card's power connection, which may be functionally maintained through one or more capacitors. The contactless card 300 may communicate back by switching a load on the contactless card's coil or load modulation. Load modulation may be detected in the terminal's coil through interference.

As explained above, the contactless card 300 may be built on a software platform operable on smart cards or other devices having limited memory, such as JavaCard, and one or more or more applications or applets (applet 340) may be securely executed. Applets may be added to contactless cards to provide a one-time password (OTP) for multiple factor authentication (MFA) in various mobile application-based use cases. Applets may be configured to respond to one or more requests, such as near field data exchange requests, from a reader, such as a mobile NFC reader (the user device 120), and produce an NDEF message that comprises a cryptographically secure OTP encoded as an NDEF text tag.

The contactless card 300 may be configured for communication with the user device 120 via a communication interface configured for establishing communication with the user device 120. The communication interface may be configured for contact-based communication, in which case the interface may have electrical circuitry and contact pads on the surface of the card 300 for establishing direct electrical communication between the card 300 and the user device 120. Alternatively or in addition, the communication interface may be configured for contactless communication with the user device 120. In such embodiments, the communication interface may be or include an NFC communication interface configured for communication with other NFC communication devices when the card 300 is within a predetermined NFC range. In some embodiments, the card 300 may include a second communication interface configured for establishing short range communication with the user device 120 via Bluetooth, or other short range communication methodology. In such embodiments, the card 300 may have a short range communication antenna that is included in or connected to the short range communication interface. The card 300 may also include a power management system for use in managing the distribution of power during an NFC transaction.

The contactless card 300 can be configured to generate and transmit a cryptogram containing MAC to the user device 120 upon tapping to the user device 120. The user device 120 may be configured to read the cryptogram from the contactless card 300 after entry of the contactless card 300 into a communication field of the user device 120. The user device 120 may then transmit the cryptogram to the server 130. The server 130 may be configured to verify the cryptogram by searching the database 140.

In some embodiments, the cryptogram can be generated by the contactless card 300 as follows. When receiving a request for authentication, the counter 345 can increment counter. The applet 340 upon execution by the processor 330 can generate two session keys (e.g., one for encryption (ENC) and one for message authentication code (MAC)) using secret keys (e.g., the nonce) combined with the counter. The applet 340 can generate a MAC with the MAC session key over the counter, the unique customer identifier (pUID) 350, shared secret, and/or an applet version number of the applet 340. The applet 340 can encrypt the MAC with the ENC session key to generate a cryptogram. The applet 340 can transmit the applet version number, pUID, counter and encrypted MAC (the cryptogram) to the user device 120. It is understood that comparable operations can be performed upon receipt of the cryptogram. In some embodiments, a nonce and potentially other predetermined fields (such as issuer ID) alongside pUID, shared secret and applet version number can be included. The nonce can help to limit the “openness” of the card in the personalization state. The issuer ID, for example can be used to identify the co-brand of the card, like a store specific card, etc.,

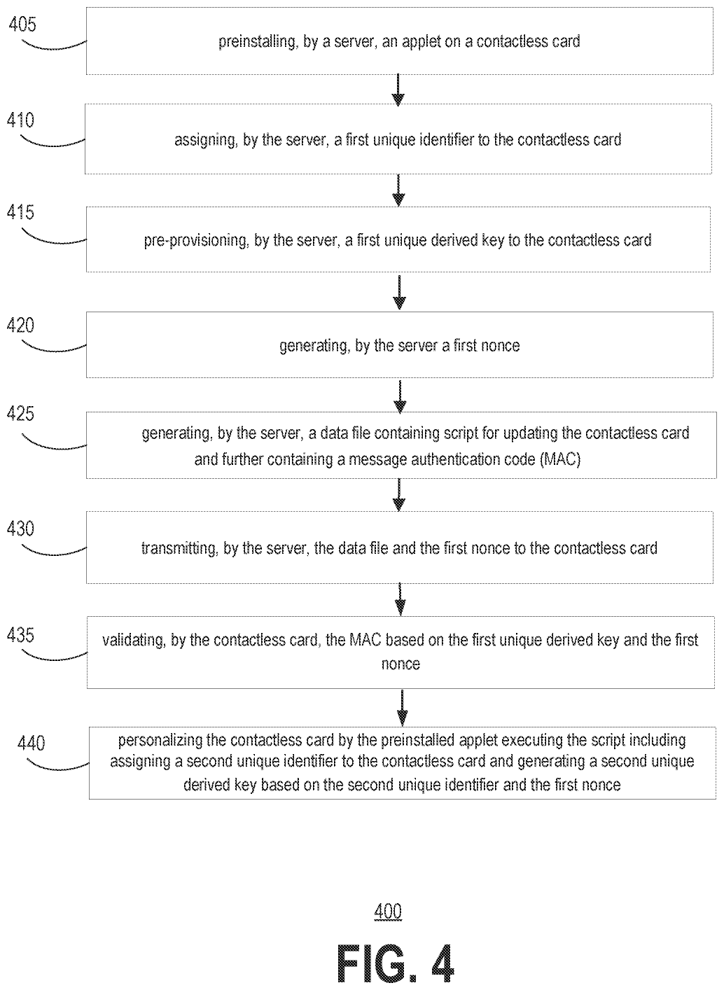

FIG. 4 illustrates a flow chart of an example method 400 for personalizing a contactless card according to an example embodiment. FIG. 4 may reference the same or similar components as those illustrated in FIGS. 1-3, including a user device, a server, a database, and a contactless card. The method 400 can be implemented in the system 100 and may include, but is not limited to the following steps.

When a user picks up a blank contactless card (e.g., the contactless card 160), for example, at a retail location, the blank contactless card needs to be personalized and/or other data changes outside of the secure card manufacturing/personalization environment.

At step 405, the blank card may be preinstalled, by a server (e.g., the server 130), an applet. At step 410, the blank card may be assigned, by the server, a first unique identifier. The first unique identifier can be used to identify the contactless card, the user of the contactless card, and/or a financial account associated with the user.

At step 415, the contactless card may be pre-provisioned, by the server, a first unique derived key. The first unique derived key may be generated by the server based on the first unique identifier and/or a secret key.

The user of the contactless card may be authenticated. For example, the user can log into his/her financial account on the user device, and the server can then authenticate the user in the back end. After authenticating the user, at step 420, the server may generate a first nonce. A nonce may be a number that can be used only once. The nonce can be a random number generated by a random number generator on the server.

At step 425, the server may generate a data file containing script for personalizing and/or updating the contactless card and further containing a message authentication code (MAC). The MAC may be generated by the server based on the first nonce, first unique derived key and/or the first unique identifier.

At step 430, the server may transmit the data file and the first nonce to the contactless card. The server may first transmit the data file and the first nonce to the user device. The user may be asked to tap the contactless card to the user device, and the user device then transmits the data file and the first nonce to the contactless card.

After receiving the data file and the first nonce, at step 435, the preinstalled applet on the contactless card may validate the MAC based on the first unique derived key and the first nonce. For example, the preinstalled applet on the contactless card may regenerate a MAC based on the first unique identifier, the first unique derived key and the first nonce, and then compare the regenerated MAC with the received MAC to determine whether they match each other. If the regenerated MAC matches with the received MAC, then the data file can be determined to be authenticated and valid. If the regenerated MAC and the received MAC do not match each other, then the data file can be determined to be fraudulent or tampered with and then can be discarded.

Once the received MAC is validated, at step 440, the contactless card can be personalized/updated by the preinstalled applet executing the script. The personalization and/or update can include assigning a second unique identifier to the contactless card, generate a second unique derived key based on the second unique identifier and the first nonce. That is, the preinstalled applet on the contactless card can execute the script contained in the data file to update or personalize the contactless card. For example, by executing the script, the preinstalled applet may derive a second derived key and additional keys based on the first unique identifier. Further, the preinstalled applet may assign a second unique identifier to the contactless card, and derive the second derived key and additional keys based on the second unique identifier. The first unique identifier may be retained or discarded. The preinstalled applet may further write to the contactless card additional information, such as information about the financial institution that issues the contactless card, and counters that can facilitate validating the contactless card.

In some embodiments, when personalizing/updating a contactless card, two secret keys such as a first nonce and a second nonce may be needed for enhancing data security. For example, the first nonce can be used by the contactless card to verify the MAC received from the server; and the second nonce can be used by the contactless card to derive a second key and additional keys.

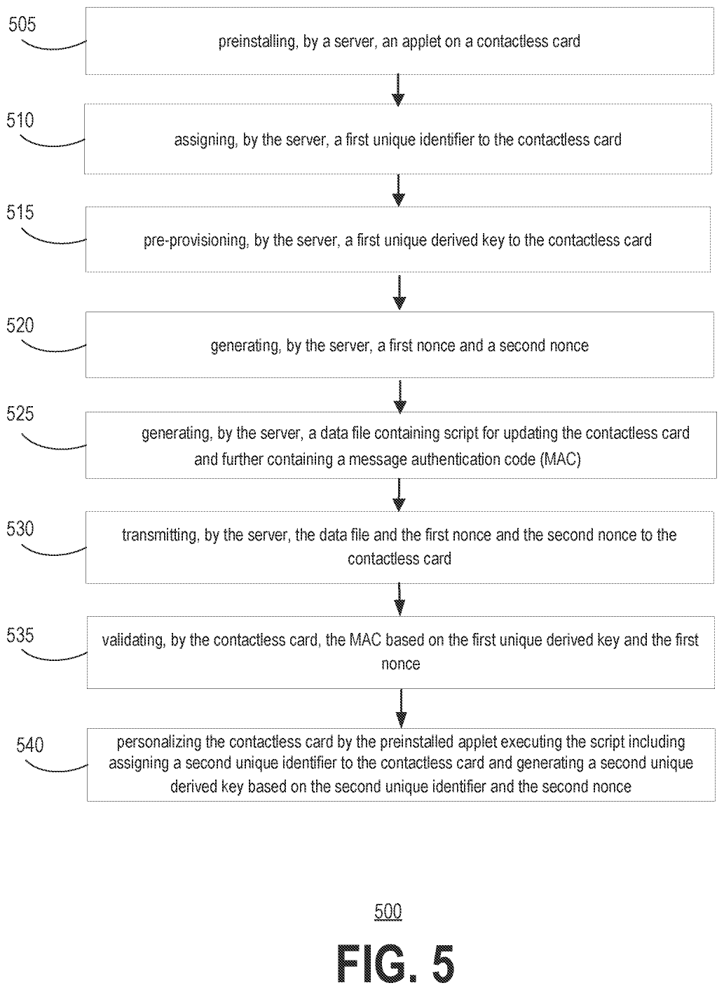

FIG. 5 illustrates a flow chart of an example method 500 for personalizing or updating a contactless card using two nonces according to an example embodiment. FIG. 5 may reference the same or similar components as those illustrated in FIGS. 1-4, including a user device, a server, a database, and a contactless card. The method 500 can be implemented in the system 100 and may include, but is not limited to the following steps.

At step 505, the server may preinstalled an applet on the contactless card. At step 510, the server may assign a first unique identifier to the contactless card. The first unique identifier can be used to identify the contactless card, the user of the contactless card, and/or a financial account associated with the user.

At step 515, the server may pre-provision on the contactless card a first unique derived key. The first unique derived key may be generated by the server based on the first unique identifier and/or a secret key (such as the first nonce).

In order to personalize or update the contactless card, the server may then authenticate the user of the contactless card. For example, the user can log into his/her financial account on the user device, and the server can then authenticate the user in the back end. After authenticating the user, at step 520, the server may generate the first nonce and the second nonce. A nonce may be a number that can be used only once. The nonce can be a random number generated by a random number generator on the server.

At step 525, the server may generate a data file containing script for personalizing and/or updating the contactless card. The data file may further contain a message authentication code (MAC) to be validated by the contactless card. The MAC may be generated by the server based on the first nonce, the first unique derived key and/or the first unique identifier.

At step 530, the server may transmit the data file, the first nonce and the second nonce to the contactless card. The server may first transmit the data file, the first nonce and the second nonce to the user device. The user may be asked to tap the contactless card to the user device, and the user device then transmits the data file, the first nonce and the second nonce to the contactless card.

After receiving the data file, the first nonce and the second nonce, at step 535, the preinstalled applet on the contactless card may validate the received MAC based on the first unique derived key and the first nonce. For example, the preinstalled applet on the contactless card may regenerate a MAC based on the first unique identifier, the first unique derived key and the first nonce, and then compare the regenerated MAC with the received MAC to determine whether they match each other. If the regenerated MAC matches with the received MAC, then the data file can be determined to be authenticated and valid. If the regenerated MAC and the received MAC do not match each other, then the data file can be determined to be fraudulent or tampered with and then can be discarded.

Once the received MAC is validated, at step 540, the contactless card can be personalized/updated by the preinstalled applet executing the script. The personalization and/or update can include assigning a second unique identifier to the contactless card, generate a second unique derived key based on the second unique identifier and the second nonce. That is, the preinstalled applet on the contactless card can execute the script contained in the data file to update or personalize the contactless card. For example, by executing the script, the preinstalled applet may derive a second derived key and additional keys based on the first unique identifier and/or a secret or public key contained in the data file. Further, the preinstalled applet may assign a second unique identifier to the contactless card, and derive the second derived key and additional keys based on the second unique identifier and the second nonce. The first unique identifier may be retained or discarded. The preinstalled applet may further write to the contactless card additional information, such as information about the financial institution that issues the contactless card, and counters that can facilitate validating the contactless card.

In some embodiments, the method and system disclosed herein can be applied to an existing contactless card. For example, an fraudulent transaction may occur to an existing contactless card, but the user still wants to retain this existing card. In this situation, the existing contactless card can be updated to write a new unique identifier, new keys, and other new information. This would enable the user to keep the existing contactless card longer.

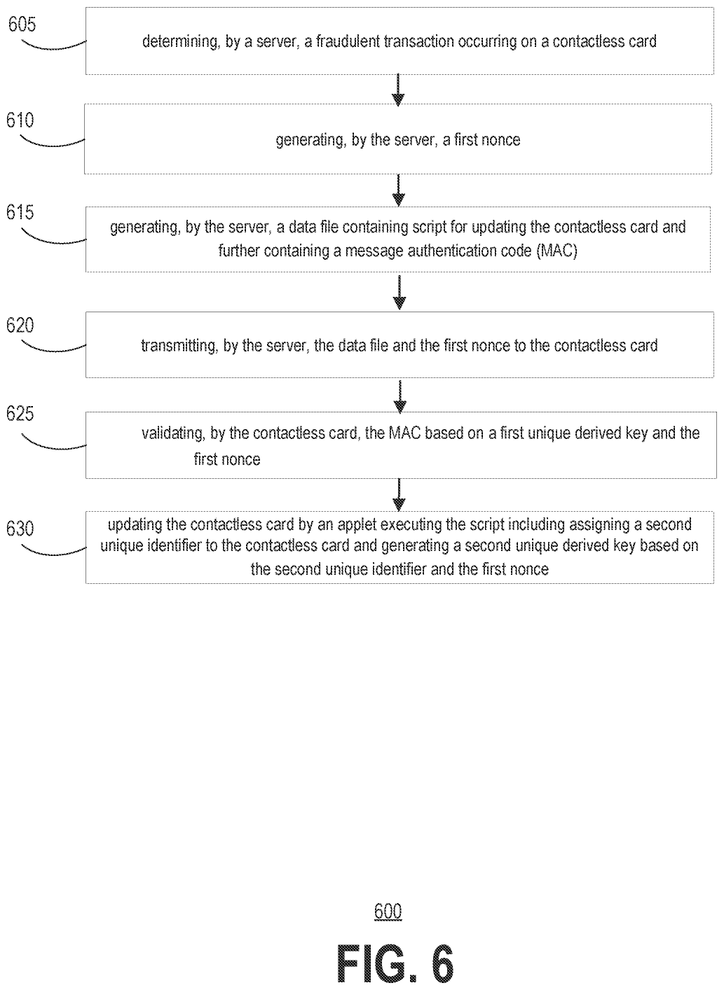

FIG. 6 illustrates a flow chart of an example method 600 for updating an existing contactless card according to an example embodiment. FIG. 6 may reference the same or similar components as those illustrated in FIGS. 1-5, including a user device, a server, a database, and a contactless card. The method 600 can be implemented in the system 100 and may include, but is not limited to the following steps.

At step 605, the server may determine a fraudulent transaction occurring on an existing contactless card. For example, the server may detect the fraudulent transaction occurring on the existing contactless card, or the user of the existing contactless card may report the fraudulent transaction to the financial institution that issues the existing contactless card.

At step 610, the server may generate a first nonce. A nonce may be a number that can be used only once. The nonce can be a random number generated by a random number generator on the server.

At step 615, the server may generate a data file containing script for updating the existing contactless card. The data file may further contain a message authentication code (MAC). The MAC may be generated by the server based on the first nonce, an existing unique derived key of the existing contactless card and/or an existing unique identifier of the existing contactless card.

At step 620, the server may transmit the data file and the first nonce to the contactless card. The server may first transmit the data file and the first nonce to the user device. The user may be asked to tap the contactless card to the user device, and the user device then transmits the data file and the first nonce to the contactless card.

After receiving the data file and the first nonce, at step 625, the existing applet on the existing contactless card may validate the received MAC based on the existing unique derived key (i.e., a first unique derived key) and the first nonce. For example, the existing applet on the contactless card may regenerate a MAC based on the existing unique identifier, the existing unique derived key and the first nonce, and then compare the regenerated MAC with the received MAC to determine whether they match each other. If the regenerated MAC matches with the received MAC, then the data file can be determined to be authenticated and valid. If the regenerated MAC and the received MAC do not match each other, then the data file can be determined to be fraudulent or tampered with and then can be discarded.

Once the received MAC is validated, at step 630, the existing contactless card can be updated by the applet executing the script. The update can include assigning a second unique identifier to the contactless card, generating a second unique derived key based on the second unique identifier and the first nonce. That is, the existing applet on the contactless card can execute the script contained in the data file to update the contactless card. For example, by executing the script, the existing applet may derive the second derived key and additional keys based on the second unique identifier. The existing unique identifier may be discarded. The applet may further write to the contactless card additional information, such as information about the financial institution that issues the contactless card, and counters that can facilitate validating the contactless card. In this way, the existing contactless card can be updated to become a new contactless card of the user without physically replacing the existing contactless card.

In some embodiments, the method and system disclosed herein can be applied to an existing contactless card. For example, an fraudulent transaction may occur to an existing contactless card, but the user still wants to retain this existing card. In this situation, the existing contactless card can be updated to write a new unique identifier, new keys, and other new information. This would enable the user to keep the existing contactless card longer.

In some embodiments, when updating the existing contactless card, two secret keys such as a first nonce and a second nonce may be needed for enhancing data security. For example, the first nonce can be used by the existing contactless card to verify the MAC received from the server; and the second nonce can be used by the existing contactless card to derive a second key and additional keys.

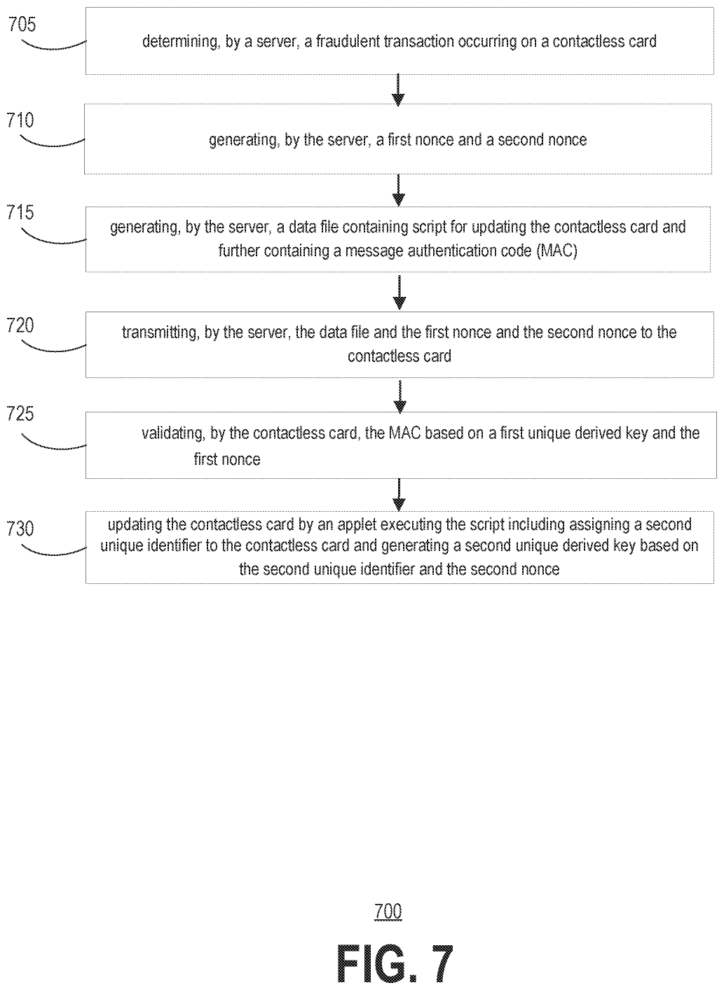

FIG. 7 illustrates a flow chart of an example method 700 for updating an existing contactless card using two nonces according to an example embodiment. FIG. 7 may reference the same or similar components as those illustrated in FIGS. 1-5, including a user device, a server, a database, and a contactless card. The method 700 can be implemented in the system 100 and may include, but is not limited to the following steps.

At step 705, a fraudulent transaction may be determined by the server to occur on an existing contactless card. For example, the server may detect the fraudulent transaction occurring on the existing contactless card, or the user of the existing contactless card may report the fraudulent transaction to the financial institution that issues the existing contactless card.

At step 710, the server may generate a first nonce and a second nonce. A nonce may be a number that can be used only once. The two nonces can be a random number generated by a random number generator on the server.

At step 715, the server may generate a data file containing script for updating the existing contactless card. The data file may further contain a message authentication code (MAC). The MAC may be generated by the server based on the first nonce, an existing unique derived key of the existing contactless card and/or an existing unique identifier of the existing contactless card.

The server may then authenticate the user of the existing contactless card. For example, the user can log into his/her financial account on the user device, and the server can then authenticate the user in the back end. At step 720, the server may transmit the data file, the first nonce and the second nonce to the contactless card. The server may first transmit the data file, the first nonce and the second nonce to the user device. The user may be asked to tap the existing contactless card to the user device, and the user device then transmits the data file, the first nonce and the second nonce the first nonce to the existing contactless card.

After receiving the data file and the first nonce, at step 725, the existing applet on the existing contactless card may validate the received MAC based on the existing unique derived key (i.e., a first unique derived key) and the first nonce. For example, the existing applet on the contactless card may regenerate a MAC based on the existing unique identifier, the existing unique derived key and the first nonce, and then compare the regenerated MAC with the received MAC to determine whether they match each other. If the regenerated MAC matches with the received MAC, then the data file can be determined to be authenticated and valid. If the regenerated MAC and the received MAC do not match each other, then the data file can be determined to be fraudulent or tampered with and then can be discarded.

Once the received MAC is validated, at step 730, the existing contactless card can be updated by the applet executing the script. The update can include assigning a second unique identifier to the contactless card, generating a second unique derived key based on the second unique identifier and the second nonce. That is, the existing applet on the contactless card can execute the script contained in the data file to update the contactless card. For example, by executing the script, the existing applet may derive the second derived key and additional keys based on the second unique identifier and/or the second nonce. The existing unique identifier may be discarded. The applet may further write to the existing contactless card additional information, such as information about the financial institution that issues the existing contactless card, and counters that can facilitate validating the existing contactless card. In this way, the existing contactless card can be updated to become a new contactless card of the user without physically replacing the existing contactless card.

In some aspects, the techniques described herein relate to a method for personalizing a contactless card, including: preinstalling, by a server, an applet on the contactless card; assigning, by the server, a first unique identifier to the contactless card; pre-provisioning, by the server, a first unique derived key to the contactless card; generating, by the server a first nonce; generating, by the server, a data file containing script for updating the contactless card and further containing a message authentication code (MAC); transmitting, by the server, the data file and the first nonce to the contactless card; validating, by the contactless card, the MAC based on the first unique derived key and the first nonce; and personalizing the contactless card by the preinstalled applet executing the script.

In some aspects, the techniques described herein relate to a method, wherein the first unique derived key is derived by diversifying the first unique identifier by the server.

In some aspects, the techniques described herein relate to a method, further including assigning, by the server, a second unique identifier to the contactless card.

In some aspects, the techniques described herein relate to a method, further including tapping, by a user, the contactless card to a mobile phone of the user to receive the data file and the first nonce.

In some aspects, the techniques described herein relate to a method, further including authenticating, by the server, a user of the contactless card through the user logging into a card application installed on a mobile phone of the user.

In some aspects, the techniques described herein relate to a method, further including retrieving, by the server, the first unique identifier from the contactless card by the user tapping the contactless card to the mobile phone.

In some aspects, the techniques described herein relate to a method, wherein the script containing interpreted byte codes.

In some aspects, the techniques described herein relate to a method, wherein the MAC is generated by the server using the first unique derived key.

In some aspects, the techniques described herein relate to a method, wherein the MAC is generated by the server using the first nonce.

In some aspects, the techniques described herein relate to a method, wherein the action of personalizing the contactless card includes generating a second unique derived key for the contactless card to replace the first unique derived key.

In some aspects, the techniques described herein relate to a system for personalizing a contactless card, including a server, the server configured to: preinstall an applet on the contactless card; assign a first unique identifier to the contactless card; pre-provision a first unique derived key to the contactless card; generate a first nonce; generate a data file containing script for updating the contactless card and further containing a message authentication code (MAC); transmit the data file and the first nonce to the contactless card; cause the contactless card to validate the MAC based on the first unique derived key and the first nonce; and cause the preinstalled applet to execute the script for personalizing the contactless card.

In some aspects, the techniques described herein relate to a system, wherein the action of personalizing the contactless card includes generating a second unique identifier for the contactless card to replace the first unique identifier.

In some aspects, the techniques described herein relate to a system, wherein the first unique derived key is derived by diversifying the first unique identifier by the server.

In some aspects, the techniques described herein relate to a system, wherein the action of personalizing the contactless card includes generating a second unique derived key for the contactless card to replace the first unique derived key.

In some aspects, the techniques described herein relate to a system, wherein the server is further configured to authenticate a user of the contactless card through the user logging into a card application installed on a mobile phone of the user.

In some aspects, the techniques described herein relate to a system, wherein the server is further configured to retrieve the first unique identifier from the contactless card by a user tapping the contactless card to a mobile phone of the user.

In some aspects, the techniques described herein relate to a method, wherein the MAC is generated by the server using the first nonce.

In some aspects, the techniques described herein relate to a system, wherein the script containing interpreted byte codes.

In some aspects, the techniques described herein relate to a method, wherein the MAC is generated by the server using the first unique derived key.

In some aspects, the techniques described herein relate to a non-transitory, computer-readable medium including instructions for personalizing a contactless card that, when executed on a computer arrangement, causes the computer arrangement to perform actions including: preinstalling an applet on the contactless card; assigning a first unique identifier to the contactless card; pre-provisioning a first unique derived key to the contactless card; generating a first nonce; generating a data file containing script for updating the contactless card and further containing a message authentication code (MAC); transmitting the data file and the first nonce to the contactless card; causing the contactless card to validate the MAC based on the first unique derived key and the first nonce; and causing the preinstalled applet to execute the script for personalizing the contactless card.

As used herein, the term “contactless card” is not limited to a particular type of card. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

As used herein, the terms “account” or “online account” are not limited to a particular type of account. Rather, the terms “account” or “online account” can refer to accounts having any purpose including, without limitation, a credit account, a debit account, a membership account, a loyalty account, a rewards account, a savings account, a checking account, a brokerage account, a retirement account, a service account, a subscription account, a utilities account, and a government account.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a contactless card, a user device, a call center device, a server, a database, and/or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for personalizing a contactless card, comprising:
preinstalling, by a server, an applet on the contactless card;
assigning, by the server, a first unique identifier to the contactless card;
pre-provisioning, by the server, a first unique derived key to the contactless card;
generating, by the server a first nonce;
generating, by the server, a data file containing script for updating the contactless card and further containing a message authentication code (MAC);
transmitting, by the server, the data file and the first nonce to the contactless card;
validating, by the contactless card, the MAC based on the first unique derived key and the first nonce; and
personalizing the contactless card by the preinstalled applet executing the script.

2. The method according to claim 1, wherein the first unique derived key is derived by diversifying the first unique identifier by the server.

3. The method according to claim 1, further comprising assigning, by the server, a second unique identifier to the contactless card.

4. The method according to claim 1, further comprising tapping, by a user, the contactless card to a mobile phone of the user to receive the data file and the first nonce.

5. The method according to claim 1, further comprising authenticating, by the server, a user of the contactless card through the user logging into a card application installed on a mobile phone of the user.

6. The method according to claim 5, further comprising retrieving, by the server, the first unique identifier from the contactless card by the user tapping the contactless card to the mobile phone.

7. The method according to claim 1, wherein the script containing interpreted byte codes.

8. The method according to claim 1, wherein the MAC is generated by the server using the first unique derived key.

9. The method according to claim 1, wherein the MAC is generated by the server using the first nonce.

10. The method according to claim 1, wherein the action of personalizing the contactless card includes generating a second unique derived key for the contactless card to replace the first unique derived key.

11. A system for personalizing a contactless card, comprising a server, the server configured to:
preinstall an applet on the contactless card;
assign a first unique identifier to the contactless card;
pre-provision a first unique derived key to the contactless card;
generate a first nonce;
generate a data file containing script for updating the contactless card and further containing a message authentication code (MAC);
transmit the data file and the first nonce to the contactless card;
cause the contactless card to validate the MAC based on the first unique derived key and the first nonce; and
cause the preinstalled applet to execute the script for personalizing the contactless card.

12. The system according to claim 11, wherein the action of personalizing the contactless card includes generating a second unique identifier for the contactless card to replace the first unique identifier.

13. The system according to claim 11, wherein the first unique derived key is derived by diversifying the first unique identifier by the server.

14. The system according to claim 11, wherein the action of personalizing the contactless card includes generating a second unique derived key for the contactless card to replace the first unique derived key.

15. The system according to claim 11, wherein the server is further configured to authenticate a user of the contactless card through the user logging into a card application installed on a mobile phone of the user.

16. The system according to claim 11, wherein the server is further configured to retrieve the first unique identifier from the contactless card by a user tapping the contactless card to a mobile phone of the user.

17. The system according to claim 11, wherein the MAC is generated by the server using the first nonce.

18. The system according to claim 11, wherein the script containing interpreted byte codes.

19. The system according to claim 11, wherein the MAC is generated by the server using the first unique derived key.

20. A non-transitory, computer-readable medium comprising instructions for personalizing a contactless card that, when executed on a computer arrangement, causes the computer arrangement to perform actions comprising:
preinstalling an applet on the contactless card;
assigning a first unique identifier to the contactless card;
pre-provisioning a first unique derived key to the contactless card;
generating a first nonce;
generating a data file containing script for updating the contactless card and further containing a message authentication code (MAC);
transmitting the data file and the first nonce to the contactless card;
causing the contactless card to validate the MAC based on the first unique derived key and the first nonce; and
causing the preinstalled applet to execute the script for personalizing the contactless card.
